(19) United States
(12) Patent Application Publication
(10) Pub. No.: US 2008/0043782 A1
(43) Pub. Date: Feb. 21, 2008

(54) Method and apparatus for checking the position of a receive window

(76) Inventors: Maurizio Skerlj, Munchen (DE); Michael Bruennert, Munchen (DE); Claudio Andreotti, Munchen (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/505,130

(22) Filed: Aug. 15, 2006

(51) Int. Cl. H04J 3/06

(52) U.S. Cl. 370/516

(57) ABSTRACT

A method checks a position of a receive window. The method includes checking whether a signal to be received within the receive window is within a reduced window within the receive window and shorter in length than the receive window.

### BACKGROUND

In many electronic devices, communication between various circuit elements of the electronic device is handled via a bus to which the circuit elements are connected. In such a case, in principle every circuit element may act both as a receiver for receiving data via the bus or as a transmitter which transmits data via the bus to another circuit element. As a matter of course, there may be some circuit elements which only transmit or only receive data.

Every circuit element connected to the bus (also referred to as bus participant) can take over the bus for a defined time and transmit data during this defined time. The scheduling which determines which circuit element may use the bus during which time period is generally handled by an arbitration protocol and may be managed, for example, by a dedicated bus managing unit or also by a conventional processing unit. One or more of the circuit elements connected to the bus may also mange the arbitration protocol.

When, during such a time period, a circuit element sends data to be received by another circuit element, this other circuit element has to be open for receiving data during a corresponding time period in order to be able to receive the data. The time period for receiving the data is referred to as a receive window. One possibility for enabling the correct circuit element for receiving the data is to send a corresponding receive enable signal which comprises an identifier identifying the receiving circuit element to the other circuit element. The receive enable signal for example may set to a logic 1 during the period in which the circuit element is to be open or enabled to receive data.

Data sent by the transmitting circuit element during the time period is referred to as a data burst. In source synchronous communication systems, as found for example in communications via bus systems of double data rate 2 dynamic random access memory (DDR2 DRAMs), a strobe signal or clock signal is transmitted with the data burst and used at the receiving circuit element to sample the data, for example by supplying the strobe signal to a clock input of a register and supplying the data burst to a data input of the register. The data burst and the strobe signal together are herein generally referred to as a burst.

The approximate time of arrival of the data burst and the strobe signal at the receiving circuit element is, with a certain accuracy, known from the arbitration protocol or bus allocation protocol used (i.e., determined by a clock cycle with which the bus is clocked). On the other hand, the exact position of the data burst and the strobe signal in time at the receiver depends on multiple factors like trace length of wires connecting the circuit elements with the bus or transmitter delays. These delays shift the exact position of the data burst and the strobe signal by fractions of clock cycles on the bus and may also vary during system operation, for example due to temperature fluctuations and supply voltage changes. Therefore, the data burst and the strobe signal may be at least partially outside the receive window of the receiving circuit element, which may lead to loss of data or incorrect receipt of the data.

A conventional technique to alleviate this problem is to add a guard band to each data burst and strobe signal. Before the burst begins, the transmitter already sends a known state called a preamble, and after the burst the transmitter stays active for a postamble. Correspondingly, the receiver is enabled for a longer time (i.e., a time corresponding to the total signal transmitted by the transmitting circuit element), (i.e., preamble, burst, and postamble), which allows shifts in the bursts due to delays without moving the burst out of the receive enable window.

However, this technique reduces the available bandwidth of the bus because there is no actual data transmission in the guard bands. Therefore, it is generally desirable to keep these guard bands as short as possible. Consequently, there is a tradeoff between the accuracy of the receive window positioning and the guard band length and available channel bandwidth. Longer guard bands allow a larger shift of the burst without leaving the receive window, but on the other hand reduce the available bandwidth.

In order to limit the length of the guard bands, conventionally offline calibration algorithms are employed during phases where no regular data transmission occurs (e.g., during a system start). For these offline calibrations, a known series of bursts is transmitted over the bus and their position is measured. Correction values are obtained based on these measurements which are used to correct the receive windows as determined by the bus allocation protocol.

Such an offline calibration algorithm cannot be executed frequently because during the execution of this algorithm no data transmission can be carried out. In many cases, such an offline calibration algorithm is only performed during system start. Consequently, the correction obtained will only cover static effects like interconnect delays which only depend on geometries, but will not cover circuit delay changes caused, for example, by supply voltage variations or temperature variations or also noise because these values change during system operation. Moreover, if the time constant for these changes are small compared to the interval according to which such an offline calibration algorithm is performed, they cannot be detected by the calibration.

Consequently, the guard bands explained above are typically kept large enough to cover such variations.

For these and other reasons, there is a need for the present invention.

### SUMMARY

One embodiment of a method of checking a position of a receive window includes checking whether a signal to be received within the receive window is within a reduced window within the receive window and shorter in length than the receive window.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a block diagram of one embodiment of a bus system.

FIG. 2 illustrates exemplary signals in the bus system of FIG. 1.

FIG. 3A illustrates one embodiment of an apparatus configured to check the position of a receive window.

FIG. 3B illustrates one embodiment of an apparatus configured to check the position of a receive window.

FIG. 4 illustrates exemplary signals in the embodiments of FIGS. 3A and 3B.

FIG. 5 is a flow diagram of one embodiment of a method of checking the position of a receive window.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Embodiments of methods and apparatuses check the position of a receive window. A receive window, in this respect, generally designates a period of time where a receiver for receiving signals, such as communication signals, is enabled to actually receive a signal.

One embodiment of a method for checking the position of a receive window includes checking whether a signal to be received within the received window is within a reduced window within the receive window and shorter in length than the receive window.

One embodiment of an apparatus includes a checker configured to check whether a signal to be received within the receive window is within a reduced window comprised within receive window and shorter in length than the receive window.

In one embodiment, when the checking determines that the signal to be received is not within the reduced window, this means that the signal is closer to the boundaries of the receive window than the boundaries of the reduced window. As a result, embodiments can provide early detection of shifts of the signal to be received respective to the receive window.

Embodiments of a method and an apparatus for checking the position of the receive window with respect to data to be received may be employed during actual data transmission so as to be able to continuously correct the position of the receive window.

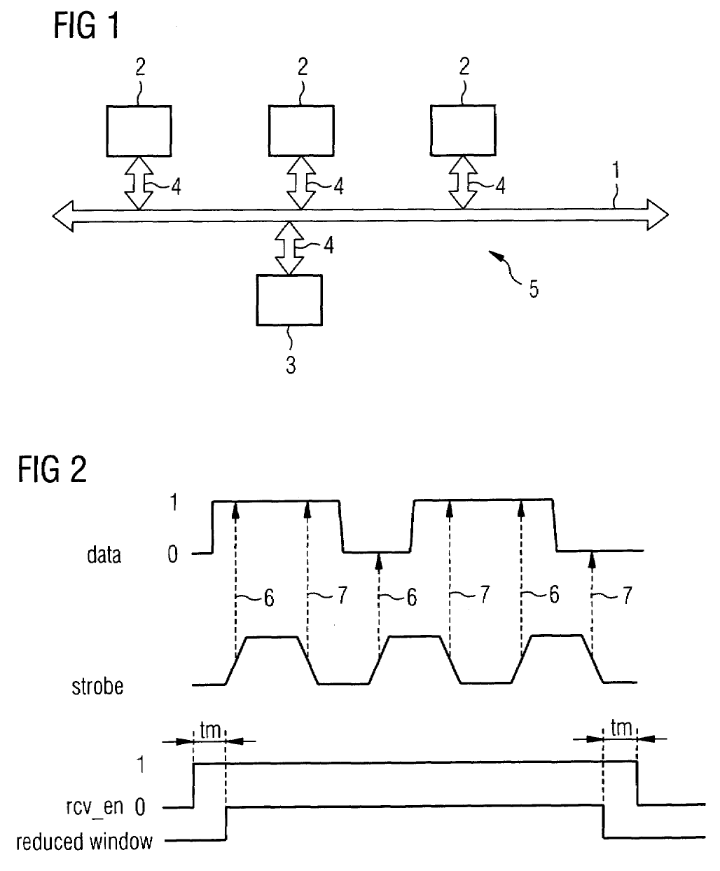

In the following, embodiments will be described with reference to the drawings. In FIG. 1, as an example of an environment in which the embodiments may be implemented, one embodiment of a bus system 5 is illustrated. Bus system 5 illustrated in FIG. 1 comprises a bus 1 and circuit elements 2, 3 connected to a bus 1 as indicated by arrows 4. Each of circuit elements 2, 3 may be designed to transmit data via bus 1, receive data via bus 1 or both.

In the embodiment illustrated, circuit element 3 acts as a bus manager (i.e., it allocates time slots for transmitting data via the bus to the circuit elements 2, 3 using a suitable bus allocation protocol or arbitration protocol). A circuit element transmitting data in a certain time slot will for the following explanation be referred to as transmitting circuit element. Each of the circuit elements 2, 3 represented in FIG. 1 may act as such a transmitting circuit element in an appropriate time slot.

Such transmitted data is intended for some other circuit element 2, 3 connected to bus 1. Similar to as explained in the Background, via the bus allocation protocol and bus manager 3, a receive window is enabled in the intended receptor of the data, in the following called receiving circuit element. Again, each of the circuit elements 2, 3 may act as receiving circuit element.

The bus system illustrated in FIG. 1 may be a bus system using source synchronized signaling, meaning that together with data burst strobe pulses are sent as a clock signal, the data burst and the strobe signal collectively referred to herein as burst. Such signaling is, for example, commonly used in memory devices like DDR2 DRAMs.

This source synchronous communication in the bus system 5 of FIG. 1 are now explained with reference to FIG. 2.

In FIG. 2, a data burst labeled “data” and a strobe signal labeled “strobe” are illustrated as an example for signals which may be sent by a transmitting circuit element in FIG. 1. The data burst and the strobe signal are received by the receiving circuit element which is activated by a received enable signal rcv_en which is also illustrated in FIG. 2 and labeled as “rcv_en”, wherein the receiving circuit element is activated when the receive enable signal assumes a logical 1 and is disabled when the receive enable signal assumes a logical 0. The receive enable signal is generated according to the bus allocation protocol, for example by bus manager 3, and may comprise an identifier to identify the circuit element it is intended for. The time during which the receive enable signal rcv_en assumes a logical 1 corresponds to the already mentioned receive window.

The receiving circuit element samples the data burst controlled by the strobe signal, for example by supplying the strobe signal to a clock input of a register and supplying the data burst to a data input of a register. For sampling the data burst, the rising edges of the strobe signal as indicated by arrows 6, the falling edges of the strobe signal as indicated by arrows 7 or both edges may be used. For example, in DDR-RAMs, generally both the rising and the falling flanks or edges are used, which in the example illustrated in FIG. 2 would lead to a “110110” being sampled, whereas for example in single data rates (SDR)-RAMs only the rising edges corresponding to arrows 6 are used, which would lead to a “1010” being sampled in the example illustrated in FIG. 2.

Similar to as discussed in the Background, the position of the receive window and thus the position of the receive enable signal rcv_en may be adjusted at startup of the bus system by using suitable test sequences of data and strobe pulses.

According to the embodiments discussed next, it is possible to monitor slight changes in the position of the data burst and the strobe signal relative to the receive window and therefore correct corresponding deviations during the normal operation of bus system 5 without the need for interrupting data transmission.

Embodiments check whether the strobe signal is within a reduced window which is depicted at the bottom of FIG. 2, the borders of which are distanced in time from the borders of the receive window by a given margin time tm. In embodiments, tm is selected to be greater than the maximum drift of the strobe signal and the data burst (which are sent by the same transmitting circuit element and therefore received at the same time by the receiving circuit element) with respect to the receive window during a predetermined number of clock cycles of the bus (e.g., one or two clock cycles). In this respect, note that such a drift can be caused both by a drift of the receive window and by a drift of the data burst and the strobe signal.

If the strobe signal (and thus the data burst) leaves the reduced window, this means that the strobe signal comes close to the borders of the actual receive window and therefore the receive window should be adjusted accordingly. In other words, embodiments can detect a drift of the strobe signal within the receive window before the strobe signal (and correspondingly also the data burst) actually leaves the receive window and therefore can react accordingly.

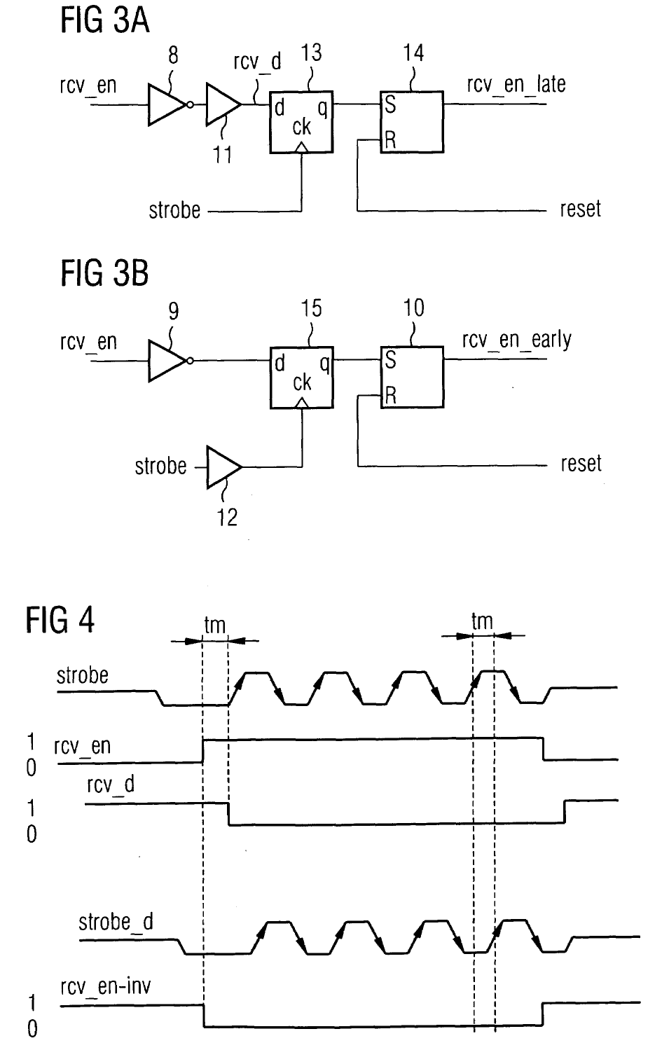

Embodiments are next described with reference to FIGS. 3A, 3B and 4, wherein FIGS. 3A and 3B illustrate circuit diagrams and FIG. 4 illustrates corresponding signals. These embodiments may, for example, be implemented within bus manager 3 of FIG. 1.

In this respect, in the embodiments of FIGS. 3A and 3B, the function for checking whether the strobe signal leaves the lower boundary of the reduced window is implemented in the circuit of FIG. 3A, whereas the function for checking whether the strobe signal leaves the upper boundary (on the right side of FIG. 2) of the reduced window is implemented in the circuit of FIG. 3B. Therefore, one embodiment for performing a complete check can comprise the circuit of FIG. 3A and the circuit of FIG. 3B. However, if in a given communication system only a drift in one direction is to be expected, it may be sufficient to use only one of the circuits of FIG. 3A and FIG. 3B.

First, the circuit embodiment illustrated in FIG. 3A is described. The receive enable signal rcv_en is fed to an inverter 8 and a delay element 11 which delays the signal by the margin time tm to produce a delayed signal rcv_d. The signals rcv_en and rcv_d are illustrated in FIG. 4.

As illustrated in FIG. 3A, the signal rcv_d is fed to a data input d of a register 13. The strobe signal strobe is supplied to a clock input of register 13 such that rcv_d is sampled controlled by the strobe signal strobe. The result of this sampling is output at an output q of register 13 and supplied to a set input S of a set/reset flip-flop 14. The set/reset flip-flop 14 outputs a late signal rcv_en_late and may be reset by applying a reset signal to a reset input R.

The functioning of the circuit of FIG. 3A will now be explained with reference to FIG. 4 and in particular the upper part thereof.

As explained above, in register 13 the delayed and inverted receive enable signal is sampled with the strobe signal strobe. As can be easily understood from FIG. 4, as long as the strobe signal begins only after the margin time from the beginning of the receive enable signal, a 0 is sampled because then the inverted and delayed receive enable signal rcv_d is 0. However, if the strobe signal drifts with respect to the receive enable signal such that it comes closer to the beginning of the receive enable signal rcv_n than the margin time tm, a 1 is sampled because then the signal rcv_d is 1. If a 1 is sampled, a 1 is also output from register 13 and applied to the set inputs of the reset flip-flop 14. Consequently, in such a case also the late signal rcv_en_late becomes 1, whereas if the strobe signal begins only after the margin time tm has passed, rcv_en_late is 0. Consequently, a value 1 of the late signal indicates that the receive window is too late (i.e., should be shifted toward an earlier time) whereas a value 0 indicates that the receive window need not be shifted to an earlier time.

In one embodiment, due to the presence of the set/reset flip-flop 14, later samplings by subsequent pulses of the strobe signal within the same burst do not change the state of the late signal. Set/reset flip-flop 14 is reset, for example by bus manager 3 of FIG. 1, after each burst so that the evaluation can be performed every burst.

Turning now to FIG. 3B, the latch circuit illustrated in this figure is somewhat similar to the latch circuit of FIG. 3A. In particular, an inverter 9 of FIG. 3B corresponds to inverter 8 of FIG. 3A, register 15 of FIG. 3B essentially corresponds to register 13 of FIG. 3A and a set/reset flip-flop 10 of FIG. 3B corresponds to set/reset flip-flop 14 of FIG. 3A. However, instead of delay element 11 of FIG. 3A, in the circuit of FIG. 3B a delay element 12 is used for delaying the strobe signal with respect to the receive enable signal which amounts to the same as negatively delaying receive enable signal rcv_en.

Therefore, the circuit illustrated in FIG. 3B samples the inverted receive enable signal with a delayed strobe signal in register 15 and outputs an early signal rcv_en_early in contrast to the late signal of FIG. 3A.

The functioning of the circuit of FIG. 3B is similar to the one of FIG. 3A and will be explained with reference to the lower part of FIG. 4. The inverted receive enable signal is labeled “rcv_en_inv” in FIG. 4, and the delayed strobe signal supplied to register 15 is labeled “strobe_d.”

As illustrated in FIG. 4, as long as the last pulse of the strobe signal and more than the margin time tm from the end of the receive enable signal rcv_n, only zeroes are sampled in register 15, and therefore the early signal rcv_en_early is 0. However, when the last pulse of the strobe signal is within the margin time tm from the end of the receive enable signal rcv_en, a 1 is sampled by this last pulse and therefore the early signal rcv_en_early is set to a value of 1.

A value of the early signal of 1 indicates that the receive window is too early and consequently should be shifted to a later position, and a value of 0 indicates that the receive window need not be shifted to a later position.

If both the circuit of FIG. 3A and the circuit of FIG. 3B are realized in the bus manager 3 of FIG. 1 or elsewhere in the bus system of FIG. 1, a late signal with value 1 means that the receive window and consequently the receive enable signal should be shifted to an earlier time, an early signal of 1 means that the receive window is too early and should be shifted to a later time, and if both the early and the late signal are 0, this means that the receive window need not be shifted and is in the correct position. This shifting may be easily performed by bus manager 3 in FIG. 1 by adjusting the times at which the receive enable signal is sent according to the bus allocation protocol accordingly. For example, depending on the late and early signals, the receive enable signal may be shifted by half the margin time tm or by the margin time tm itself.

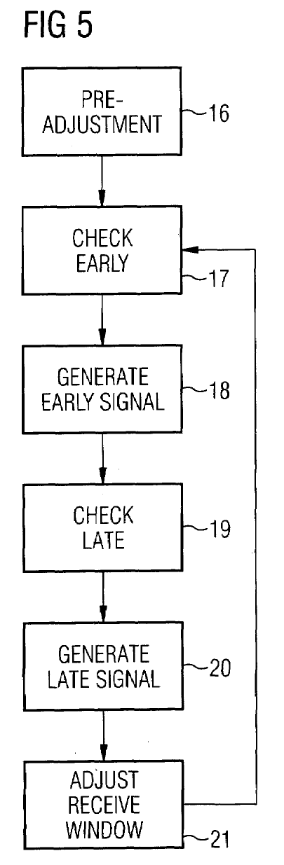

To summarize this procedure, a method according to one embodiment is illustrated in FIG. 5. At 16, a preadjustment or offline calibration is performed similar to as explained in the Background (i.e., by using suitable test bursts with suitable test data sequences to position the receive window correctly initially). Thereafter, deviations from this correct position due to voltage fluctuations, temperature fluctuations, or other sources may be detected and the position may be corrected accordingly. In particular, to do this, in the embodiment illustrated in FIG. 5, at 17 whether the receive window is too early is checked and at 18 a corresponding early signal is generated corresponding to the embodiment of FIG. 3B. At 19, whether the receive window is too late is checked, and at 20 a corresponding late signal is generated, corresponding to the embodiment of FIG. 3A. Finally, at 21 the receive window is adjusted based on the early signal and the late signal as already described.

Note that steps 17 and 18 on the one hand and steps 19 and 20 on the other hand need not be performed in this order, but the order may be reversed or steps 17 and 18 may be executed in parallel with steps 19 and 20, which for example is the case if the method is implemented by the circuits illustrated in FIGS. 3A and 3B.

Since with the described embodiments a continuous checking of the position of the receive window and a corresponding adjustment of the receive window is possible, with certain embodiments no or only small guard bands are needed, thus increasing the bandwidth of the communication channel.

The embodiment described above are only to be taken as an example, and numerous modifications and alternatives are possible within the scope of the present invention. Some of these modifications and variations will be discussed below.

In the embodiments of FIG. 3A and FIG. 3B, registers 13 and 15 may be registers which react to the rising edges of the strobe signal, the falling edges of the strobe signal or both. In case of communication systems which generally use only the rising edges for sampling (as has been explained with reference to FIG. 2 in detail), both register 13 and register 15 may be designed to sample only at the rising edges because in this case only that the rising edges need to stay within the receive window. On the other hand, if generally both the rising edges and the falling edges are used for sampling as for example in DDR-RAMs, register 13 may be adapted to sample at the rising edges of the strobe signal, whereas register 15 may be adapted to sample only at the falling edges which ensures that the rising edge of the first pulse of the strobe signal and the falling edge of the last pulse of the strobe signal stay within the receive window. In one embodiment, register 13 and 15 may also both be adapted to sample both at the rising edges and the falling edges.

In the circuits of FIG. 3A and 3B, it is also possible to realize the circuit without inverters such that the significance of zeroes and ones in the late signal and the early signal are reversed.

Furthermore, it is possible to use only one circuit instead of the two circuits of FIGS. 3A and 3B and use a variable delay element both for the receive enable signal and the strobe pulse, such that for example, during one burst the late signal is generated and during the next burst the early signal is generated.

Also other kinds of circuits may be used to generate the late signal and the early signal, for example by using D-flip-flops or other kinds of latches.

Also if generally the rising edges and the falling edges are used for sampling, registers 13 and 15 may be adapted to use only the rising edges of the strobe signals for sampling. In this case, to ensure that the falling edge of the strobes also stays within the receive signal, the delay of delay element 12 may be increased, or a gating function may be implemented in the receiver which prevents the shutting of the receiver when receiving a high value or a rising edge such that also the falling edge of the strobe will be received before the receive window ends. In this respect, note that although the same time tm has been used in FIG. 3A and FIG. 3B, also different times may be used such that the reduced window is not positioned symmetrically within the receive window. Furthermore, note that the use of the invention is not restricted to bus systems like the one illustrated in FIG. 1, but may be used in all applications where a receiver is active only a certain time (i.e., has a receive window) which has to be checked for correct positioning and possibly adjusted.

Moreover, if no source synchronous signaling as explained with reference to FIG. 2 is used, a clock signal for sampling the data is usually generated in some manner, for example from the data bursts themselves using some clock recovery mechanism. In such cases, this recovered clock signal may be used for carrying out an embodiment.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of checking a position of a receive window, comprising:
checking whether a signal to be received within the receive window is within a reduced window within the receive window and shorter in length than the receive window.

2. The method according to claim 1,
wherein a first boundary of the reduced window is spaced by a first predetermined time from a first boundary of the receive window; and
wherein a second boundary of the reduced window is spaced by a second predetermined time from a second boundary of the receive window.

3. The method according to claim 2, wherein the first predetermined time is equal to the second predetermined time.

4. The method according to claim 1, comprising:
adjusting the position of the receive window if the result of the checking indicates that the signal to be received is not completely within the reduced window.

5. The method according to claim 1, wherein the checking comprises:
checking whether the start of the signal is earlier than the beginning of the reduced window; and
checking whether the end of the signal is later than the end of the reduced window.

6. The method according to claim 1, comprising:
adjusting the position of the receive window using test signals.

7. The method according to claim 6, wherein the adjusting is performed at a start-up of a communication system implementing the method.

8. The method according to claim 1, wherein the method is implemented in a bus system of a memory device.

9. A method of checking a position of a receive window, wherein a signal comprising a strobe signal is to be received within the receive window, the method comprising:
delaying a derived signal to form a delayed signal, wherein the derived signal is derived from an enabling signal for enabling the receive window;
sampling the delayed signal with the strobe signal to obtain at least one first sample;
delaying the strobe signal with respect to the enabling signal to form a delayed strobe signal; and
sampling the derived signal with the delayed strobe signal to obtain at least one second sample.

10. The method according to claim 9, wherein the derived signal is substantially identical to the enabling signal.

11. The method according to claim 9, wherein the derived signal is formed by inverting the enabling signal.

12. The method according to claim 9, comprising:
adjusting the position of the receive window based on the at least one first sample and on the at least one second sample.

13. The method according to claim 12, wherein the adjusting comprises:
forming a first adjustment signal indicating whether the position of the received window is to be shifted to an earlier position based on the first sample;
forming a second adjustment signal indicating whether the position of the receive window is to be shifted to a later position based on the at least one second sample; and
adjusting the position of the receive window based on the first adjustment signal and the second adjustment signal.

14. The method according to claim 9, wherein the samplings are controlled by rising edges of the strobe signal and the delayed strobe signal, respectively.

15. The method according to claim 9,
wherein the sampling to obtain the at least one first sample is controlled by rising edges of the strobe signal; and
wherein the sampling to obtain the at least one second sample is controlled by falling edges of the delayed strobe signal.

16. The method according to claim 9, wherein the strobe signal is a clock signal for sampling a data signal sent together with the strobe signal.

17. An apparatus for checking a position of a receive window, comprising:
means for checking whether a signal to be received within the receive window is within a reduced window within the receive window and shorter in length than the receive window.

18. The apparatus according to claim 17,
wherein a first boundary of the reduced window is spaced a first predetermined time from a first boundary of the receive window; and
wherein a second boundary of the reduced window is spaced from a second boundary of the receive window by a second predetermined time.

19. The apparatus according to claim 18, wherein the first predetermined time is equal to the second predetermined time.

20. The apparatus according to claim 17, comprising:
means for adjusting the position of the receive window if the result of the checking indicates that the signal to be received is not completely within the reduced window.

21. The apparatus according to claim 17, wherein the means for checking comprises:
means for checking whether the start of the signal is earlier than the beginning of the reduced window; and
means for checking whether the end of the signal is later than the end of the reduced window.

22. The apparatus according to claim 17, comprising:
means for adjusting the position of the receive window using test signals.

23. The apparatus according to claim 22, comprising:
means for activating the means for adjusting at a start-up of the apparatus.

24. An apparatus for checking a position of a receive window, wherein a signal comprising a strobe signal is to be received within the receive window, the apparatus comprising:
a first delay element configured to delay a derived signal to form a delayed signal, wherein the derived signal is derived from an enabling signal for enabling the receive window;
a first sampling element configured to sample the delayed signal with the strobe signal to obtain at least one first sample;
a second delay element configured to delay the strobe signal with respect to the enabling signal to form a delayed strobe signal; and
a second sampling element configured to sample the derived signal with the delayed strobe signal to obtain at least one second sample.

25. The apparatus according to claim 24, wherein the derived signal is substantially identical to said enabling signal.

26. The apparatus according to claim 24, comprising:
an inverter configured to invert the enabling signal to form the derived signal.

27. The apparatus according to claim 24, comprising:
an adjusting element configured to adjust the position of the receive window based on the at least one first sample and on the at least one second sample.

28. The apparatus according to claim 27, wherein the adjusting element comprises:
a first forming element configured to form a first adjustment signal indicating whether the position of the received window is to be shifted to an earlier position based on the first sample;
a second forming element configured to form a second adjustment signal indicating whether the position of the receive window is to be shifted to a later position based on the at least one second sample; and
an adjusting element configured to adjust the position of the receive window based on the first adjustment signal and the second adjustment signal.

29. The apparatus according to claim 24, wherein the first and second sampling elements are controlled by rising edges of the strobe signal and the delayed strobe signal, respectively.

30. The apparatus according to claim 24,
wherein the first sampling element is controlled by rising edges of the strobe signal; and
wherein the second sampling element is controlled by falling edges of the delayed strobe signal.

31. The apparatus according to claim 24, wherein the strobe signal is a clock signal for sampling a data signal sent together with the strobe signal.

32. An apparatus for checking a position of a receive window, the receive window being enabled by an enable signal and indicating the time during which a signal comprising a strobe signal is to be received, the apparatus comprising:
a first input terminal configured to receive the enable signal;
a second input terminal configured to receive the strobe signal;
a first register including:
a data input operatively coupled to the first input terminal; and
a clock input operatively coupled to the second input terminal; and
a first delay element operatively coupled between the first input terminal and the data input of the first register.

33. The apparatus according to claim 32, comprising:
a second register including:
a data input operatively coupled to the first input terminal; and
a clock input operatively coupled to the second input terminal; and
a second delay element operatively coupled between the second input terminal and the clock input of the second register.

34. The apparatus according to claim 33, comprising:
at least one storage coupled to an output of at least one of the first register and the second register.

35. The apparatus according to claim 34, wherein the storage comprises:
a set/reset flip-flop including a set input operatively coupled to at least one of the output of the first register and the output of the second register.

36. The apparatus according to claim 33, comprising:
at least one inverter coupled between the first input terminal and at least one of the data input of the first register and the data input of the second register.

37. An apparatus for checking a position of a receive window, the receive window being enabled by an enable signal and indicating the time during which a signal comprising a strobe signal is to be received, the apparatus comprising:
a first input terminal configured to receive the enable signal;
a second input terminal configured to receive the strobe signal;
a first register including:
a data input operatively coupled to the first input terminal; and
a clock input operatively coupled to the second input terminal; and
a first delay element operatively coupled between the second input terminal and the clock input of the first register.
